(19) United States
(12) Patent Application Publication
(10) Pub. No.: US 2015/0095099 A1
(43) Pub. Date: Apr. 2, 2015

(54) RAPID ASSESSMENT OF EMERGING RISKS

(71) Applicant: Bank of America Corporation, Charlotte, NC (US)

(72) Inventors: Daniel C. Kern, Charlotte, NC (US); David A. Hogeboom, Davidson, NC (US)

(73) Assignee: Bank of America Corporation, Charlotte, NC (US)

(21) Appl. No.: 14/041,079

(22) Filed: Sep. 30, 2013

(51) Int. Cl. G06Q 10/06

(52) U.S. Cl. CPC G06Q 10/0635
USPC 705/7.28

(57) ABSTRACT

Apparatus and methods described herein may rapidly identify emerging risks that may impact an entity. Methods may update and identify emerging risks on a frequent basis. Using an electronic form, information may be collected from a filtered set of experts. The set of experts may be “filtered” based on the emerging risk and a scope of the emerging risk. The information may include the experts' responses to a set of questions. The information may include values on absolute scales. The information may be analyzed to determine variation in the responses of the experts. The information may be aggregated across a plurality of emerging risks and across a plurality of lines-of-business. Based on the information, a convergence point may be determined. The convergence point may identify a time at which a combined impact of each of the plurality of emerging risks exceeds a risk threshold of an entity.

### FIELD OF TECHNOLOGY

Aspects of the invention relate to quantitatively and rapidly identifying and evaluating a potential impact of emerging risks situations.

### BACKGROUND

Scenario Analysis is a technique/process used in the financial industry to evaluate a potential risk facing a bank or other financial institutions (hereinafter “entity”). Scenario Analysis includes defining a “What if?” hypothetical scenario. Experts may be invited to discuss their opinions relating to a potential impact of the emerging risk scenario on the entity. Typically, Scenario Analysis involves time consuming workshops to evaluate a potential impact of the scenario. Experts may spend a substantial amount of time, sometimes days, evaluating a single scenario.

Scenario Analysis involves open discussions among the experts. The open discussions may be susceptible to the loudest or most vocal participant biasing group opinion in favor of a particular point-of-view. Typical Scenario Analysis is susceptible to subjective “feelings” of the expert participants. The subjective nature of the input collected as a result of typical Scenario Analysis is difficult to scale and/or compare across different scenarios, lines-of-business or geographic regions.

It would be desirable to provide “Rapid Scenario Analysis.” It would be desirable to frequently and rapidly identify relevant scenarios based on news headlines, recent losses, earnings reports or other triggers. It would be desirable to evaluate a potential impact of an emerging risk scenario in a matter of days rather than weeks or months.

It would further be desirable to minimize participant bias by collecting inputs from experts independently. It would further be desirable to obtain inputs that allow for comparison of potential impacts across a plurality of emerging risk scenarios. It would further be desirable to obtain results of an emerging risk scenario analysis that may be aggregated across lines-of-business or geographic regions.

Therefore, it would be desirable to provide apparatus and methods for rapid assessment of emerging risks.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative apparatus in accordance with principles of the invention;

FIG. 2 shows an illustrative arrangement in accordance with principles of the invention;

FIG. 3A shows illustrative information in accordance with principles of the invention;

FIG. 3B shows illustrative information in accordance with principles of the invention;

FIG. 3C shows illustrative information in accordance with principles of the invention;

FIG. 4 shows illustrative information in accordance with principles of the invention;

FIG. 5 shows illustrative information in accordance with principles of the invention;

FIG. 6 shows illustrative information in accordance with principles of the invention; and

FIG. 7 shows an illustrative process in accordance with principles of the invention.

### DETAILED DESCRIPTION OF THE INVENTION

Apparatus and methods for rapidly assessing emerging risk situations (hereinafter “emerging risk”) are provided.

Methods may include assessing an emerging risk associated with a line-of-business (“LOB”). The LOB may be operated by an entity. The emerging risk may represent a hypothetical scenario. The emerging risk may be a based on a current news event. For example, the emerging risk may represent a potential resolution to a political crisis or regional conflict.

The emerging risk may be identified based on a trigger. The trigger may be identified by a computer algorithm. The computer algorithm may search for potential triggers. The algorithm may search for potential triggers at specified intervals. The trigger may reflect a concern of an employee of the entity or LOB, a news event, a fiscal report of the LOB has passed a threshold or other suitable triggers.

The method may include selecting a group of experts to assess the emerging risk. An expert may be selected from a pool of experts. The group of experts may be selected from the pool of experts. The expert may be selected from the pool based on a decision of the computer algorithm. The algorithm may select experts in accordance with a specified distribution. For example, the algorithm may be programmed to optimize selection of experts from the pool such that any one expert is not selected a threshold number of times more than another expert is selected.

The pool of experts may include individuals that possess specific subject matter expertise. An expert may be added to the pool based on a recommendation of an employee of the entity. For example, a manger may nominate a subordinate as an expert based the subordinates past job performance. The manager may specify the area in which the subordinate possess expertise. A subordinate may nominate a manager as an expert.

An expert may be selected from the pool if the expert possesses specific subject matter knowledge relating to the trigger and/or emerging risk. A computer algorithm may determine which experts possess subject matter expertise most appropriate to assess the identified emerging risk. Exemplary experts may include recognized industry leaders, university professors, Currency experts, regulatory experts, customer behavior experts or any other suitable expert.

The method may include generating a questionnaire. The questionnaire may be generated electronically. The questionnaire may be generated based on an identity of the selected experts. The questions included in the questionnaire may probe an expert's knowledge in a specific subject matter. The questionnaire may include one or more questions regarding the emerging risk. The questionnaire may include questions relating to damage that may arise as a result of the emerging risk. The questionnaire may include questions relating to opportunities that may arise as a result of the emerging risk. The selected group of experts may be asked to answer the questions.

The experts may be asked to answer the questions using numbers. The experts may be asked to answer a question using words. The questionnaire may include questions relating to when the emerging risk may materialize. Illustrative questions and illustrative answers are shown below in Table 1.

TABLE 1
Illustrative Questions and Answers

| Illustrative Question | Illustrative Response |
|---|---|
| How prepared is the LOB to | Satisfactory Control |
| mitigate the emerging risk? | Environment |
| Describe the details of the | [EXPERT PROVIDED SPACE |
| level of preparation to | TO FILL-IN RESPONSE] |
| mitigate the emerging risk | |
| Specify whether the impact will | Weekly |
| occur in a single event or in | Monthly |
| repeating events | Quarterly |
| What do you expect the financial | |
| impact to be per “event” if | |
| the risk materializes? In other | |
| words if the risk will be | |
| experience monthly, what is the | |
| monthly impact? | |
| I am 90% certain that the impact | $5,000,000 |
| will be at least | $10,000,000 |
| I am 90% certain that the impact | $100,000,000 |
| will not be more than | $70,000,000 |
| What do you expect the | Remote (unlikely news coverage, |
| reputational impact to be if the | little customer awareness) |
| risk materializes? | Possible (average news coverage, |
| | regional customer awareness) |
| | Likely (large amount of news |
| | coverage, national customer |
| | awareness) |
| How likely do you think the risk | |
| described above is to materialize? | |
| I feel 90% confident the | 10 |
| probability of the risk | 20% |
| materializing will be at least: | 30% |
| I feel 90% confident the proba- | 60% |
| bility of the risk materializing | 70% |
| will not be more than: | 80% |
| When do you expect the risk to | |
| materialize? | |
| I am 90% certain the risk will | [EXPERT SELECTS DATE] |
| not materialize before: | |
| I am 90% certain the risk will | [EXPERT SELECTS DATE] |
| not materialize later than: | |
| Please provide any additional | [EXPERT PROVIDED SPACE |
| information that explains the | TO FILL-IN RESPONSE, ABILITY |
| details of rationale for your input | TO ATTACH SUPPORTING |
| | DOCUMENTATION] |

The emerging risk may be a first emerging risk. The group of experts may be a first group of experts. The first group of experts may be selected based on the first emerging risk. The first group of experts may be selected based on one or more characteristics or attributes of the first emerging risk.

For example, the first emerging risk may be associated with a specific country. The first questionnaire may be transmitted to experts knowledgeable about the culture and/or business practices in the specified country. If the emerging risk is associated with a potential effect of a political crisis on a regional financial market, the group of experts may include at least one expert able to assess the impact of the political crisis on the regional financial market. In some embodiments, each expert included in the group of experts may be selected based on possessing knowledge and/or expertise relating to at least one characteristic or attribute associated with the emerging risk. A computer algorithm may determine a “mix” of experts having different areas of expertise to be included in the selected group of experts. Illustrative characteristics of emerging risk are show below in Table 2.

TABLE 2
Illustrative Emerging Risk Characteristics.

Illustrative Emerging Risk Characteristics
Impact on credit card processing
Regional/national/global scope
Political change
Regulatory change
Legal change
Reporting/disclosure requirement
Safety hazard
Customer behavior
Public relations
Human resources

The questionnaire may be a first questionnaire. The first questionnaire may be generated based on the first emerging risk. Based on responses provided by the first group of experts to the first questionnaire, the methods may include plotting, along a time axis, a projected materialization associated with the first emerging risk. The projected materialization may be an estimate, based on responses to the questionnaire, of when, if ever, the emerging risk may materialize. The projected materialization may include an earliest time for materialization. The projected materialization may include a latest time for materialization.

The methods may include, based on the responses to the first questionnaire, plotting, along a cost axis, a projected impact on the LOB. The impact may be associated with the first emerging risk. The impact may be a cost to the LOB. The impact may include an estimate of how the emerging risk may impact the LOB. The LOB may be impacted even if the emerging risk does not fully materialize as projected by the experts. For example, an emerging risk may impact the LOB if the emerging risk is not ameliorated by a time prior to a deadline even if the emerging risk does not actually materialize by the deadline. The effect may be a financial effect on the LOB. The financial effect may be a monetary loss. The financial effect may be a monetary gain.

The methods may include identifying a second group of experts to assess a second emerging risk. The second group of experts may be identified based on one or more of the techniques used to select the first group of experts. The methods may include generating a second questionnaire based on the second group of experts and the second emerging risk. Based on responses provided by the second group of experts to the second questionnaire the methods may include plotting, along the time axis, a projected materialization associated with the second emerging risk. The projected materialization may correspond to an estimate of when, if ever, the second emerging risk may materialize.

Based on the responses provided by the second group of experts to the second questionnaire, the methods may include plotting, along the cost axis, a projected effect associated with the second emerging risk. The effect may be a monetary loss, monetary gain or any other potential impact associated with the second emerging risk.

The methods may include calculating a convergence point. At the convergence point: (1) a combined monetary loss associated with the first and second emerging risks may be above a threshold loss, and (2) a period of time until the projected materialization of the first and second emerging risks is less than a threshold time period.

The convergence point may correspond to a point in time at which the first and second risks are likely to materialize, and if the first and second emerging risks do materialize, the impact on the LOB may exceed a threshold loss. In some embodiments, a convergence point may be calculated to identify a financial gain or opportunity that may accrue to the LOB if the first and second emerging risks materialize within the threshold time period.

A single convergence point may not exist for the first and second emerging risks. A plurality of convergence points may be calculated for the first and second emerging risks.

The methods may include assigning a first distribution of time to the projected materialization of the first emerging risk. The methods may include assigning a first distribution of values to the projected monetary loss of the first emerging risk. The methods may include assigning a second distribution of time to the projected materialization of the second emerging risk. The methods may include assigning a second distribution of values to the projected monetary loss of the second emerging risk. A distribution may be assigned based on an analysis of the responses to a questionnaire. A distribution may be assigned based on a characteristic of the emerging risk. Illustrative characteristics are shown above in Table 2.

The distributions assigned to the materialization or impact may be determined based on responses received from the selected experts. The distributions assigned to the materialization or monetary loss may be determined based on a variation in the responses received from the selected experts. For example, the responses to the first questionnaire may fit a normal distribution. The first distribution may be a uniform distribution.

When the responses of a group of experts to a questionnaire vary by more than a threshold variance, the methods may include submitting a second questionnaire to the same group of experts. Receiving responses that vary by more than a threshold variance may indicate a lack of consensus among the selected experts. The second questionnaire may include different questions from those included in the initial questionnaire. In some embodiments, the second questionnaire may be submitted to second group of experts.

The methods may include identifying a first emerging risk at a first time. The methods may include identifying a second emerging risk at a second time. The methods may include determining a convergence point within 24 hours of the first time. The methods may include determining a convergence point within 24 hours of the second time.

The LOB may be a first LOB. When the LOB is a first LOB, the methods may include identifying a second LOB associated with one or more emerging risks that potentially impact the first LOB. For example, an entity may operate a plurality of LOBs. If a convergence point indicates that a first LOB is likely to be substantially impacted by a first a second emerging risk, the entity may determine if any of the other of the plurality of LOBs are also likely to be impacted by the first and second emerging risks.

Apparatus may include a computer program product. The product may be configured to rapidly assess a plurality of emerging risks. The product may include a non-transitory computer readable medium having computer readable program code embodied therein. The product may include a processor. The product may be executed by a processor. The processor may be configured to execute the computer readable program code.

The computer readable program code when executed by the processor may implement an algorithm for rapidly assessing a plurality of emerging risks. The algorithm may identify each of the plurality of emerging risks. For each of the plurality of emerging risks, the algorithm may identify a set of experts to assess the emerging risk. The set of experts may be selected from among a pool of experts.

For each of the plurality of emerging risks, the algorithm may plot a first plurality of points on a time axis. The first plurality of points may correspond to a range of times. The range of times may include an earliest expected materialization of the emerging risk. The range of times may include a latest expected materialization of the emerging risk. The range of times may have any suitable length, such as one hour, one day, seven days, two weeks, thirty days, one-month, three months, six months, one year, two years, five years or any other suitable length.

The algorithm may plot a second plurality of points on a cost axis. The second plurality of points may correspond to a range of values. The range of values may include a minimum expected loss associated with the emerging risk. The range of values may include a maximum expected loss associated with the emerging risk.

The algorithm may plot a third plurality of points on an organizational axis. The third plurality of points may include a plurality of lines-of-business (“LOBs”) expected to be impacted by an emerging risk. The algorithm may identify the plurality of LOBs based on the set of experts selected to assess each of the emerging risks. The algorithm may identify the plurality of LOBs based on characteristics of each of the emerging risks. The algorithm may identify each of the plurality of LOBs based on responses of experts to a questionnaire.

The algorithm may calculate, for each of the plurality of LOBs, if a threshold expected loss is expected to materialize within a threshold time period. The algorithm may determine if a LOB is able to sustain the threshold impact within the threshold time period. Whether the LOB may sustain the threshold impact may be depend on current business activities on the LOB.

The algorithm may determine if the LOB is able to sustain the threshold expected loss based on an assessment by the experts. The algorithm may determine if the LOB is able to sustain the threshold expected loss based on financial reports issued by the LOB. The algorithm may determine if the LOB is able to sustain the threshold expected loss based on a current financial status of the LOB. The algorithm may determine if the LOB is able to sustain the threshold expected loss based on any suitable criterion.

For example, if the LOB has recently made significant capital outlays, the LOB may be more vulnerable to a potential loss associated with an emerging risk. If the LOB has recently reported better than expected profits, the LOB may be less vulnerable to a potential loss associated with an emerging risk.

At a time after an earliest expected materialization of an emerging risk, the algorithm may re-plot the first plurality of points, the second plurality of points and/or the third plurality of points. The first plurality of points, the second plurality of points and/or the third plurality of points may be re-plotted in response to a change in an operational strategy implemented by one or more of the plurality of LOBs. The change in operational strategy may mitigate a potential impact of the emerging risk. The change in operation strategy may exacerbate a potential impact of the emerging risk.

The threshold time period may be a first threshold time period. The algorithm may determine if a total expected impact associated with a plurality of LOBs is expected to materialize within a second threshold time period. The total expected impact may be an aggregated loss across all of the LOBs potentially affected by an emerging risk. The total expected impact may affect the entity that operates the plurality of LOBs. For example, the algorithm may determine if the entity that operates the plurality of LOBs is able to sustain a total expected loss within the second threshold time period.

Apparatus may include a computer program product for rapidly assessing an impact of emerging risks across a plurality of geographic regions. The computer program product may include a non-transitory computer readable medium having computer readable program code embodied therein. The apparatus may include a processor configured to execute the computer readable program code. The computer readable program code when executed by the processor may implement an algorithm.

For a first geographic region, the algorithm may identify a first emerging risk associated with the first geographic region. The first emerging risk may be associated with the first geographic region based on an attribute of the first geographic region. Attributes of a geographic region may include: socioeconomics, culture, mode of governance, demographics, topology, climate or any other suitable attribute.

The algorithm may plot a first plurality of points on a graph. Each of the first plurality of points may correspond to a monetary value of a potential impact of the first emerging risk. Each of the first plurality of point may correspond to the monetary value of the potential impact at a time selected from among a range of times.

The range of times may begin at an earliest expected materialization of an emerging risk. The range of times may end at a latest expected materialization of an emerging risk. The range of times may have any suitable length, such as one hour, one day, seven days, two weeks, thirty days, one-month, three months, six months, one year, two years, five years or any other suitable length.

For a second geographic region, the algorithm may identify a second emerging risk. The second emerging risk may be associated with a second geographic region. The algorithm may plot a second plurality of points. Each of the second plurality of points may correspond to a monetary value of a potential impact of the second emerging risk. Each of the second plurality of points may correspond to the monetary value of the potential impact at a second time. The second time selected from among the range of times.

For a LOB operating in the first geographic region and the second geographic region, the algorithm may calculate a total monetary value of the first potential impact and the second potential impact. The algorithm may determine if a total monetary value of the first potential impact and the second potential impact is expected to materialize within a threshold time period. The algorithm may calculate if the LOB is able to sustain the threshold expected impact within the threshold time period.

The algorithm may update the plots generated based on the first and/or second plurality of points. The algorithm may update the plots in substantially real-time. The algorithm may update the plots at a time after the earliest expected materialization. The algorithm may update the plots before the latest expected materialization. The algorithm may update the plots at any time during the range of times.

The algorithm may re-plot the first plurality of points and/or the second plurality of points in response to a change in an operational strategy implemented by the LOB. The change in operational strategy may be implemented in the first geographic region and/or the second geographic region.

The monetary value of the first and second potential impacts may correspond to a potential loss that may accrue to the LOB if the first and/or second emerging risks materialize. The total potential impact may correspond to a total expected loss that would be borne by the LOB if the first and/or second emerging risks materialize. The algorithm may determine if the LOB is able to sustain the total expected loss during the range of times.

The monetary value of the first and second potential impacts may correspond to a potential gain that may accrue to the LOB if the first and/or second emerging risks materialize. The total potential impact may correspond to a total expected gain that would be realized by the LOB if the first and/or second emerging risks materialize. The algorithm may determine when, during the range of times, the LOB should take action to realize the total expected gain.

The monetary value of the first potential impact may correspond to a potential gain that may accrue to the LOB if the first emerging risk materializes. The monetary value of the second potential impact may correspond to a potential loss that may accrue to the LOB if the second emerging risk materializes. The total potential impact may correspond to a net expected gain that would be realized by the LOB if the first and/or second emerging risks materialize. The total potential impact may correspond to a net expected loss that would be realized by the LOB if the first and/or second emerging risks materialize. The algorithm may determine when, during the range of times, the LOB should take action to realize the total net expected gain. The algorithm may determine when, during the range of times, the LOB should take action to avoid or mitigate the total net expected loss.

Illustrative embodiments of apparatus and methods in accordance with the principles of the invention will now be described with reference to the accompanying drawings, which form a part hereof. It is to be understood that other embodiments may be utilized and that structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, solid-state memory, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

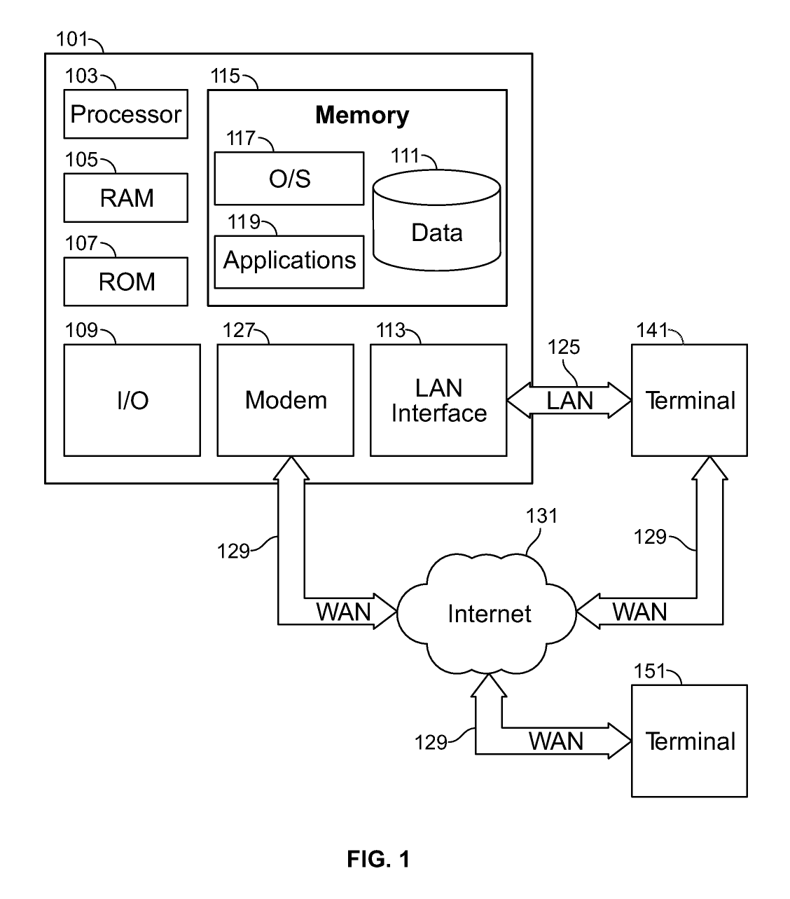

FIG. 1 is a block diagram that illustrates a computing device 101 (alternatively referred to herein as a “server” or “computer”) that may be used according to an illustrative embodiment of the invention. The computer server 101 may have a processor 103 for controlling overall operation of the server and its associated components, including RAM 105, ROM 107, input/output (“I/O”) module 109, and memory 115.

I/O module 109 may include a microphone, keypad, touch screen and/or stylus through which a user of device 101 may provide input, and may also include one or more of a speaker for providing audio output and a video display device for providing textual, audiovisual and/or graphical output. Software may be stored within memory 115 and/or other storage (not shown) to provide instructions to processor 103 for enabling server 101 to perform various functions. For example, memory 115 may store software used by server 101, such as an operating system 117, application programs 119, and an associated database 111. Alternatively, some or all of computer executable instructions of server 101 may be embodied in hardware or firmware (not shown).

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown). Terminal 151 and/or terminal 141 may be portable devices such as a laptop, tablet, smartphone or any other suitable device for receiving, storing, transmitting and/or displaying relevant information.

Any information described above in connection with database 111, and any other suitable information, may be stored in memory 115. One or more of applications 119 may implement one or more algorithms that may be used to identify emerging risks, select experts, formulate questionnaires, analyze responses to the questionnaires, calculate and plot points based on the responses to the questionnaires, calculate convergence points, model information, calculate total potential losses/gains, formulate strategies to avoid losses, formulate strategies to realize gains and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

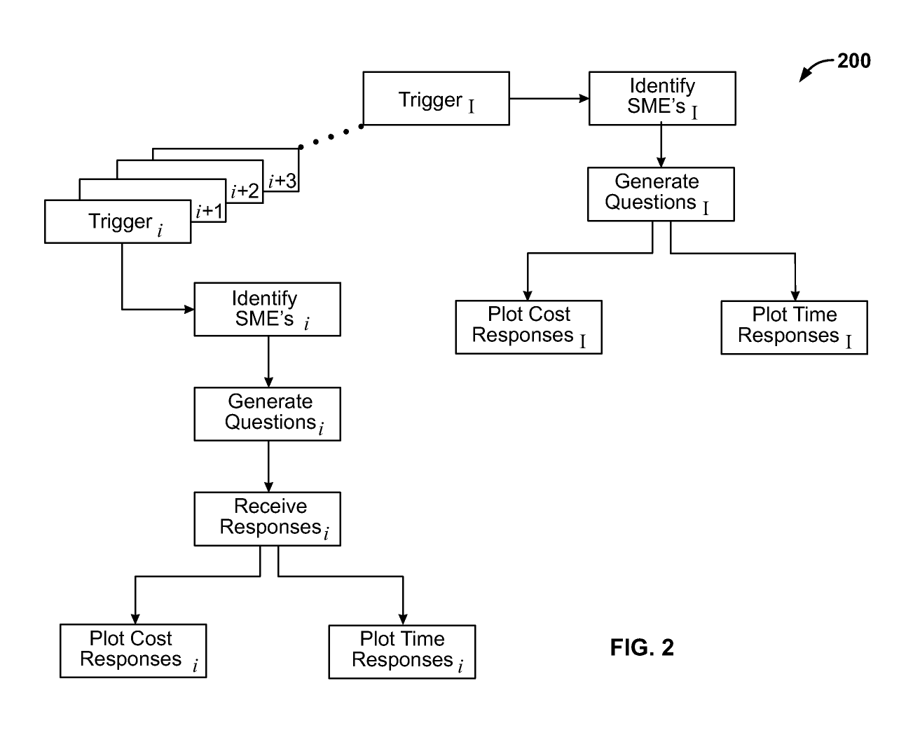

FIG. 2 shows illustrative arrangement 200. Arrangement 200 includes Triggers_{i . . . I}. For each of Triggers_{i . . . I}, a group of subject matter experts (“SME”) may be identified. For example, for Triggerᵢ, SMEs well versed in the potential impact of Triggerᵢ may be selected. For Triggerᵢ₊₃, SMEs well versed in the potential impact of Triggerᵢ₊₃ may be selected.

A series of questions_{i . . . I} may be generated. The series of questions_{i . . . I} may be generated based on the identity of the selected SMEs. For example, the series of questionsᵢ may be generated based on one or more characteristics of Triggerᵢ. Illustrative trigger characteristics are shown above in Table 2.

Based on the responses provided by SME_{i . . . I} to questions_{i . . . I}, a graphical view of the costs and time estimates may be plotted. The cost and time estimates corresponding to each of Triggers_{i . . . I} may be plotted individually. The cost and time estimates corresponding to each of Triggers_{i . . . I} may be plotted on the same graph. For each graph, a convergence point may be identified. The convergence point may correspond to a threshold impact at a threshold time.

The convergence points associated with each of Triggers_{i . . . I} may be aggregated. The aggregated convergence points may identify a total threshold impact associated with threshold time across all of Triggers_{i . . . I}. Based on the total threshold impact, an LOB may take preparatory steps to handle a potential impact associated with Triggers_{i . . . I}.

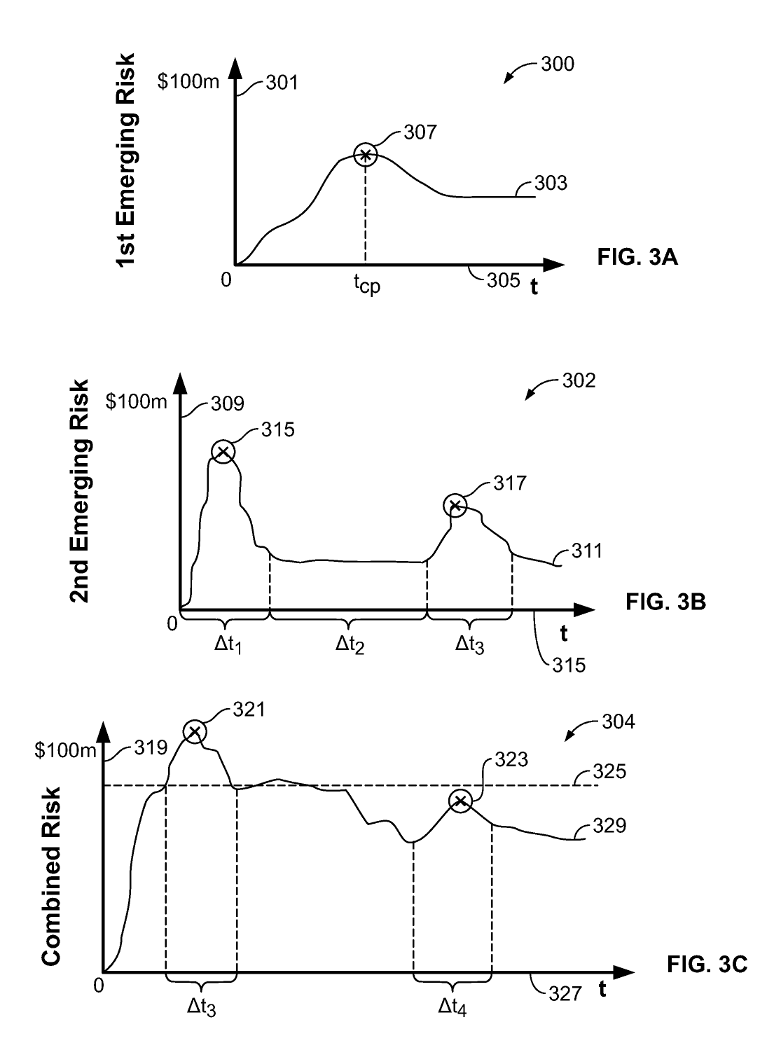

FIG. 3A shows illustrative graph 300. Graph 300 includes cost axis 301. Cost axis 301 may include any suitable range of values. Graph 300 includes time axis 305. Time axis 305 may include any suitable range of times. Axes 301 and 305 may include ranges suitable for determining if and how a LOB may be impacted by a first emerging risk.

Graph 300 includes plot 303. Plot 303 may be determined based on responses of experts to a questionnaire. The responses to the questionnaire may be submitted by a group of subject matter experts. Each subject matter expert included in the group may submit their own response. The questionnaire may pose questions to the selected subject matter experts regarding a first emerging risk.

The questionnaire may be an electronic form. The experts may enter answers to the questions by entering information into the electronic form. Each subject matter expert included in the selected group of experts may submit their own response to the questionnaire. The questionnaire may pose question to selected subject matter experts regarding an emerging risk. Illustrative questions are shown above in Table 1.

Graph 300 includes convergence point 307. Convergence point 307 may correspond to a cost of a materialization of the first emerging risk that may be greater than a “risk appetite” of the LOB evaluating the first emerging risk. Graph 300 shows that convergence point 307 is calculated occur at time t_{cp}. After time t_{cp}, graph 300 shows that a potential cost associated with a materialization of the first emerging risk may have less of an impact on the LOB.

FIG. 3B shows graph 302. Graph 302 includes plot 311. Plot 311 shows a potential cost over time if a second emerging risk were to materialize. Plot 311 may be determined based on responses to a questionnaire. The questionnaire may be submitted to a selected group of experts. The experts may submit their responses to questions included in the questionnaire.

Plot 311 may be generated based on the responses of the selected group of experts. Graph 300 shows that plot 311 includes two convergence points, 315 and 317. Convergence point 315 may correspond to an assessment that a LOB may realize a first threshold loss if the second emerging risk materializes within Δt₁. A LOB may not be prepared to sustain the threshold loss when the threshold loss occurs within a time period corresponding to Δt₁.

Convergence point 317 may correspond to an assessment that a LOB may realize a first threshold loss if the second emerging risk materializes within Δt₃.

In some scenarios, an LOB may be able to withstand the potential impact associated with convergence point 315. Convergence point 317 may correspond to an assessment that the LOB may realize a second threshold loss within a period of time Δt₂ following the first threshold loss associated with convergence point 315.

The period of time corresponding to Δt₂ may correspond to a time period that does not allow the LOB enough time to recover from the impact associated with convergence point 315. In such scenarios, although an LOB may be able to “weather” the impact associated with convergence point 315, the LOB may be unable to withstand the combined impact of convergence points 315 and 317 when they both occur within Δt₂.

FIG. 3C shows graph 304. Graph 304 includes plot 329. Plot 329 may be an aggregation of plots 303 and 311 (shown above in FIGS. 3A and 3B). In some scenarios, neither graph 300 nor graph 302 may, individually, include convergence points that present a worrisome risk to an LOB. However, if the first emerging risk and the second emerging risk were to both materialize, then the LOB may be presented with convergence point 321. Convergence point 321 may represent a potential impact to a LOB if both the first and second emerging risks were to materialize.

In some scenarios, graph 300 may represent a first risk that may impact a first LOB. In this scenario, convergence point 307 may not pose a problematic impact to the first LOB. Graph 302 may represent a second risk that may impact a second LOB. Neither convergence point 315, nor convergence point 317 may present a problematic impact to the second LOB. Graph 304 may represent a potential to an entity that operates the first LOB and the second LOB. Convergence point 321 may represent a combined impact of the first emerging risk on the first LOB and the impact of the second emerging risk on the second LOB. The entity may not be able to withstand the potential impact associated with convergence point 321.

Conversely, neither the first LOB nor the second LOB individually may be able to withstand the impact of convergence point 321 or the impact of convergence point 323. The entity that operates the first and second LOBs may have a different risk tolerance than each of the LOBs. For example, the entity may be able to withstand the impact associated with convergence point 323 but not the impact associated with convergence point 321. The entity may have a risk tolerance level corresponding to 325.

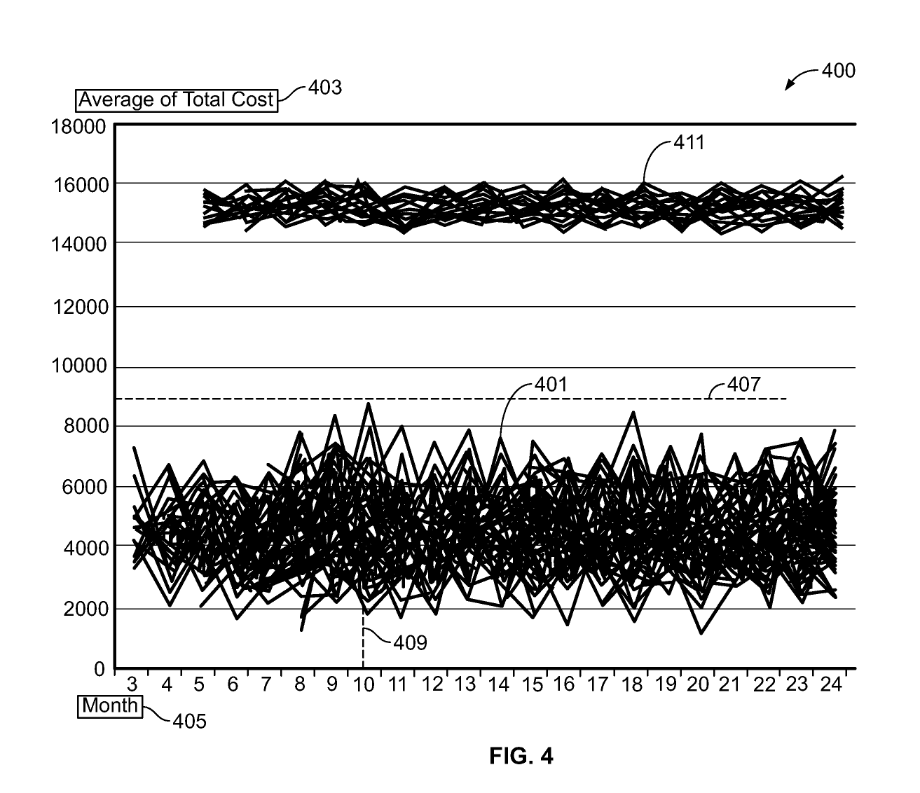

FIG. 4 shows illustrative information 400. Information 400 includes cost axis 403. Cost axis 403 includes increments of “average total cost.” The average total cost may be determined based on responses to a questionnaire received from a selected group of experts. The responses of the selected experts may be modeled using any suitable distribution. The average cost may be measured in currency, such as USD, CAN, EUR, YEN or any suitable currency. The average cost may be measured using a unit-less normalized scale. Information 400 includes time axis 405. Time axis 405 includes time increments of one month.

Information 400 includes plots 401. Plots 401 may correspond to a plurality of emerging risks. In some embodiments (not shown), each of the plurality of emerging risks may include a plot that is color coded. The color coding may allow for visual identification of a plot corresponding to a specific emerging risk.

Information 400 shows that, generally, the potential impact of the plurality of emerging risks will be associated with an average cost between 2000 and 8000. Information also shows that there is at least one emerging risk that may materialize at point 409 (about mid-way through month no. 10) resulting in an average cost of 9000. Based on information 400, an LOB or entity may assess whether to take any preventive action to mitigate a cost or impact of an emerging risk.

Information 400 includes aggregated impact 411. Aggregated impact 411 may correspond to a total average impact if all of the emerging risk were to materialize. Information 400 shows that the total average impact would be approximately 1500. The LOB or entity may assess a likelihood or probability of all or some of the plurality of emerging risk materializing at substantially the same time or during a range of times. The likelihood or probability may be determined based on responses to a questionnaire received from the experts selected to assess each of the emerging risks.

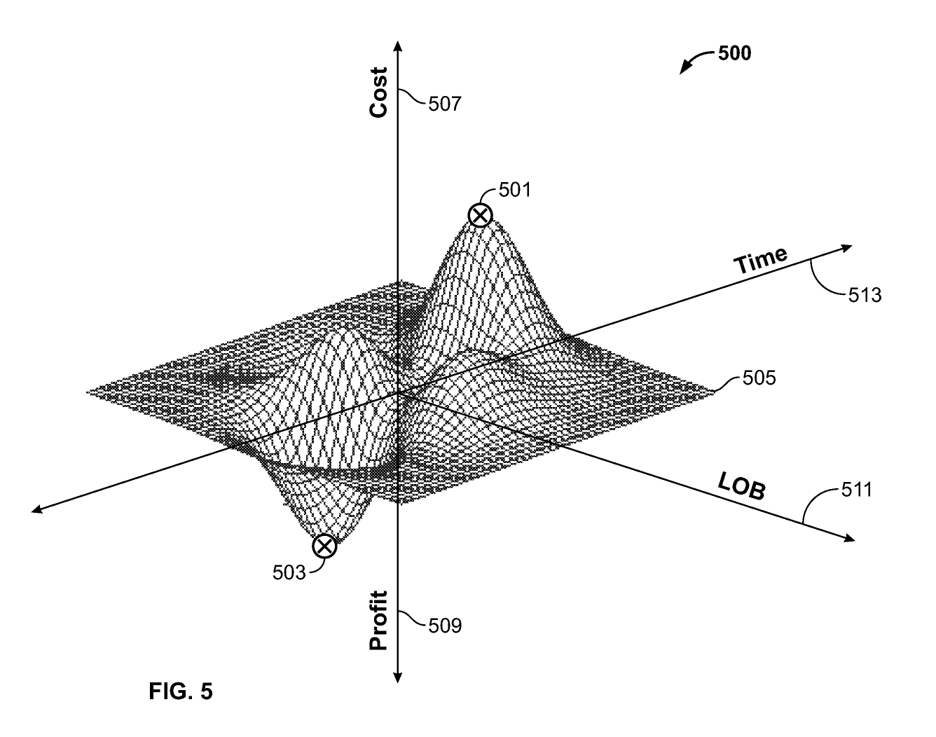

FIG. 5 shows illustrative information 500. Information 500 includes cost axis 507. Cost axis 507 may include any suitable units of measuring cost. Information 500 includes time axis 513. Time axis 513 may include any suitable units of time. Information 500 includes line-of-business (“LOB”) axis 511. Each unit on LOB axis 511 may include a plurality of LOBs that may be impacted by an emerging risk.

Based on an assessment by a selected group of experts, illustrative surface plot 505 may be generated. Surface plot 505 may show a potential impact of a plurality of emerging risk on a plurality of LOBs. Each of the plurality of LOBs may be potentially impacted by a plurality of emerging risks. Surface plot 505 may show a potential impact of the plurality of emerging risks on an entity that operates the plurality of LOBs. Surface plot 505 may allow the entity to identify LOBs at risk for potentially large impacts if one or more of the emerging risks materialize.

For example, surface plot 505 includes convergence point 501. Convergence point 501 may represent a potential impact of one or more emerging risks affecting one or more LOBs operated by an entity. The potential impact (indicated on cost axis 507) associated with convergence point 501 may be greater than a risk tolerance or risk threshold of the entity. After identifying convergence point 501, the entity may take steps to mitigate a potential impact of convergence point 501. The entity may implement a change in operational strategy for one or more of the LOBs included on axis 511.

Information 500 includes profit axis 509. In some embodiments, a plurality of emerging risks may present a business opportunity for one or more LOBs. The plurality of emerging risk may be aggregated to determine a potential impact of a potential business opportunity. Each LOB operated by an entity may be presented with potential business opportunities. Based on plot 505, the entity may identify a point in time when it may be advantageous to concurrently take advantage of a plurality of business opportunities.

For example, information 500 includes convergence point 503. At convergence point 503 a plurality of LOBs may each be presented with at least one business opportunity. At convergence point 503, an aggregated potential profit of each LOB acting on its business opportunity may present a valuable opportunity to the entity.

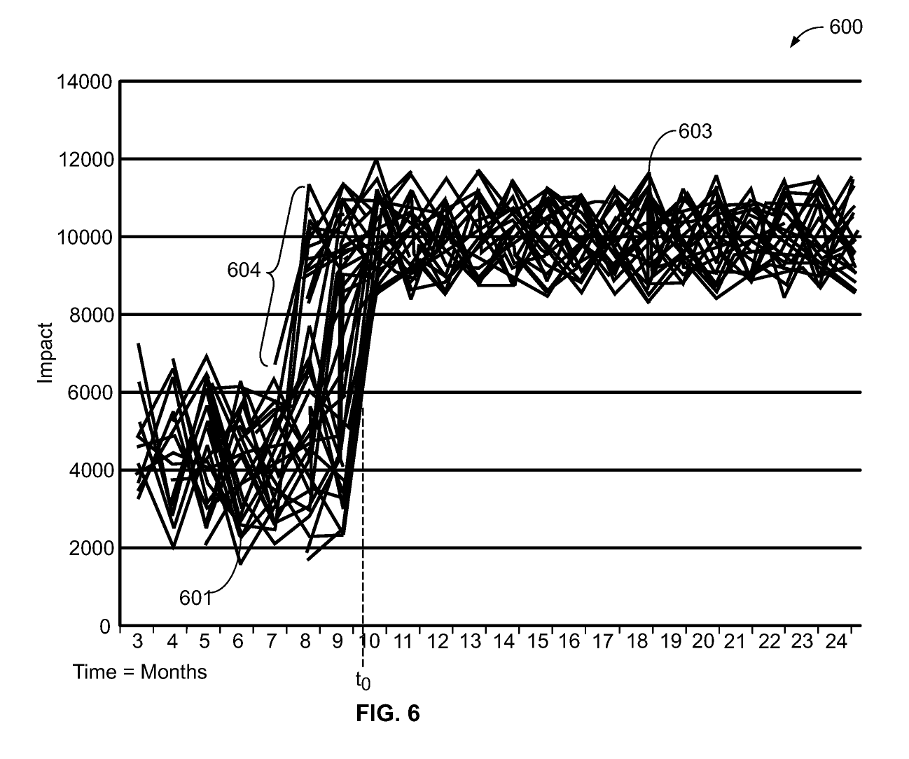

FIG. 6 shows illustrative information 600. Information 600 includes plot 601. Plot 601 may include a projected potential impact over time of a plurality of emerging risks. Information 600 shows that at time t₀, plot 601 includes a sharp increase in the potential impact of the plurality of emerging risks. Based on 601, an LOB or entity may determine what occurs at t₀ that exacerbates the projected impact of the plurality of emerging risks. The LOB or entity may determine what occurs at t₀ based on submitting plot 601 to a selected group of experts. The LOB or entity may determine what occurs at t₀ using any suitable analytical tool or approach.

After identifying “spike” 604 in plot 601, a LOB or entity may take precautions to avoid materialization of the potential impact. In some embodiments, the sharp increase may represent a potential business opportunity. In such embodiments, a LOB or entity implement procedures to capitalize on the business opportunity at t₀. For example, the entity may instruct each of its LOBs to act on a business opportunity at or near time t₀.

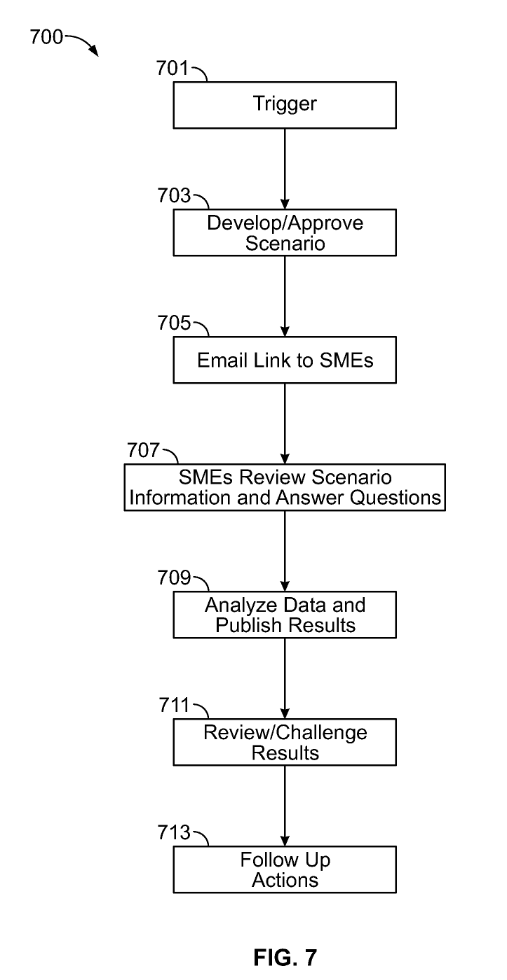

FIG. 7 shows illustrative process 700. For the sake of illustration, one or more of the steps of the process illustrated in FIG. 7 will be described as being performed by a “system.” The “system” may include one or more of the features of the apparatus, arrangements, information or processes shown in FIGS. 1-6 and/or any other suitable device or approach. The “system” may be provided by an entity. The entity may be an individual, an organization or any other suitable entity.

Process 700 may begin at step 701. At step 701, the system may identify a trigger. The trigger may correspond to an emerging risk. The system may identify the trigger based on a known or expected emerging risk. A known emerging risk may include a regularly occurring emerging risk. A known emerging risk may include a seasonal emerging risk. The system may identify the trigger based on a result of an internal or external assessment. Such an assessment may include a fiscal audit or earnings report. The system may identify the trigger based on news headlines.

At step 703, the system may develop and approve a scenario. The scenario may provide a context for understanding the emerging risk. The scenario may be a hypothetical scenario. Step 703 may include developing a scenario statement. The scenario statement may outline facts describing the scenario. Step 703 may include identifying subject matter experts (“SMEs”) to assess the scenario. The subject matter experts may be identified based on an expertise associated with each SME.

In some embodiments, at step 703, the system may perform an initial evaluation of a potential impact associated with a scenario. If the impact is greater than a threshold, the scenario may be approved for further analysis by the SMEs.

Step 703 may include generating questions to probe a SME's expertise. The questions may ask a SME to evaluate an impact associated with the emerging risk. The questions may ask the SME to evaluate the impact by assigning a dollar value to the impact. The questions may ask the SME to provide an estimate of when the emerging risk and associated impact may materialize.

At step 705, the system may transmit questions developed at step 703 to a selected group of SMEs. The selected group of SMEs may include any suitable number of SMEs. For example, the selected group may include 1, 2, 30, 56, 150, 500 or 10,000 SMEs. The questions may be transmitted to an SME via an email link. A transmission of the questions to a SME may include an explanation of why the system has selected the recipient SME to evaluate the emerging risk. The transmission to the SME may explain the analysis and/or evaluation the SME is being asked to perform.

At step 707, the SME may review the scenario and respond to the questions. The SME may access a dedicated website that includes resources that may be utilized by the SME in developing responses to the questions. For example, the dedicated website may include printable supporting documentation. The system may allow the SME to respond to the questions using absolute scales (i.e., dollars vs. “1-5” rating). The system may allow the SME to respond utilizing a range of values. The system may allow the SME to provide qualitative input such explaining why the SME provided a specific value or range or values. The system may allow the SME to attach documents supporting a response of the SME.

At step 709, the system may analyze responses provided by each SME in a selected group. When analyzing the responses, the system may utilize ranges provided in individual responses to conduct advanced analysis. For example, the system may conduct an analysis of the range of responses by comparing them across groups, e.g., group 1 responses vs. group 2 and so on to quantify uncertainty. The system may combine responses received from SME's with other data sources to augment the data. Other data sources may include external loss information. The system may perform regression analysis “after the fact” when no action was taken, i.e., after the risk was expected, did it and did it match the SME's input?

The system may employ Monte Carlo simulation to present a range of possible impacts associated with an emerging risk. The ranges provided by the SMEs may be used to provide a more granular assessment of potential impacts of an emerging risk. For example, a date range of an expected materialization may allow the system to pin-point a series of days for the expected materialization rather than outputting a single impact month.

At step 711, the system may present information to decision-makers of a LOB or entity. The information may include the responses of the SMEs. The information may include system generated analysis of the responses submitted by the SMEs. The information may include information shown above in FIGS. 3A-6. The presented information may stimulate discussion among the decision-makers. Based on the presented information the discussion may be data-driven discussion. The presented information may be used to justify and/or prioritize actions of the decision-makers.

At step 713, follow-up actions may be implemented to manage a potential impact associated with an emerging risk. Exemplary actions may include monitoring the emerging risk. The monitoring may include re-calculating and/or re-plotting data associating with the emerging risk. Action may include implementing a mitigating strategy to minimize an impact of the emerging risk. In some embodiments, the action may include implementing strategies to maximize an impact of the emerging risk.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, apparatus and methods for rapid assessment of emerging risks have been provided. Persons skilled in the art will appreciate that the present invention can be practiced by other than the described embodiments, which are presented for purposes of illustration rather than of limitation. The present invention is limited only by the claims that follow.

What is claimed is:

1. A method for assessing an emerging risk associated with a line-of-business (“LOB”), the method comprising:
identifying a first group of experts to assess a first emerging risk;
generating a first questionnaire based on the first group of experts and the first emerging risk;
based on responses provided by the first group of experts to the first questionnaire:
plotting, along a time axis, a projected materialization associated with the first emerging risk;
plotting, along a cost axis, a projected monetary loss associated with the first emerging risk;
identifying a second group of experts to assess a second emerging risk;
generating a second questionnaire based on the second group of experts and the second emerging risk;
based on responses provided by the second group of experts to the second questionnaire:
plotting, along the time axis, a projected materialization associated with the second emerging risk;
plotting, along the cost axis, a projected monetary loss associated with the second emerging risk;
calculating a convergence point at which:
a combined monetary loss associated with the first and second emerging risks is above a threshold loss; and
a period of time until the projected materialization of the first and second emerging risks is less than a threshold time period.

2. The method of claim 1 further comprising:
assigning a first distribution of time to the projected materialization of the first emerging risk;
assigning a first distribution of values to the projected monetary loss of the first emerging risk;
assigning a second distribution of time to the projected materialization of the second emerging risk; and
assigning a second distribution of values to the projected monetary loss of the second emerging risk.

3. The method of claim 2 wherein:
the first distribution of time is a normal distribution; and
the first distribution of values is a uniform distribution.

4. The method of claim 1 further comprising identifying the emerging risk based on one or more news events.

5. The method of claim 1 further comprising, when the responses of the first group of experts to the first questionnaire vary by more than a threshold variance, submitting a third questionnaire to the first group of experts.

6. The method of claim 1 further comprising:
identifying the first emerging risk at a first time;
identifying the second emerging risk at a second time; and
determining the convergence point within 24 hours from a later of the first time or the second time.

7. The method of claim 1 wherein, when the LOB is a first LOB, the method further comprises identifying a second LOB associated with the first emerging risk and the second emerging risk.

8. A computer program product for rapidly assessing a plurality of emerging risks, the computer program product comprising:
a non-transitory computer readable medium having computer readable program code embodied therein; and
a processor configured to execute the computer readable program code;
the computer readable program code when executed by the processor:
identifies each of the plurality of emerging risks;
for each of the plurality of emerging risks:
plots a first plurality of points on a time axis, the first plurality of points corresponding to range of times that starts at a earliest expected materialization of the emerging risk and ends at a latest expected materialization of the emerging risk;
plots a second plurality of points on a cost axis, the second plurality of points corresponding to a range of values that starts at a minimum expected loss associated with the emerging risk and ends at a maximum expected loss associated with the emerging risk; and
plots a third plurality of points on an organizational axis, the third plurality of points corresponding to a plurality of lines-of-business (“LOBs”) expected to be impacted by the emerging risk;
calculates, for each of the plurality of LOBs:
if a threshold expected loss is expected to materialize within a threshold time period; and
if the LOB is able to sustain the threshold expected loss within the threshold time period.

9. The computer program product of claim 8 further comprising computer readable program code that when executed by the processor, for each of the plurality of emerging risks, identifies a set of experts to assess the emerging risk, the set of experts selected from among a pool of experts.

10. The computer program product of claim 9 further comprising computer readable program code that when executed by the processor identifies the plurality of LOBs based on the set of experts selected to assess each of the emerging risks.

11. The computer program product of claim 8 further comprising computer readable program code that when executed by the processor, at a time after the earliest expected materialization, re-plots the first plurality of points, the second plurality of points and the third plurality of points.

12. The computer program product of claim 11 further comprising computer readable program code that when executed by the processor, re-plots the first plurality of points, the second plurality of points and the third plurality of points in response to a change in an operational strategy implemented by one or more of the plurality of LOBs.

13. When the threshold time period is a first threshold time period, the computer program product of claim 8 further comprises computer readable program code that when executed by the processor determines if a total expected loss associated with the plurality of LOBs is expected to materialize within a second threshold time period.

14. The computer program product of claim 13 further comprising computer readable program code that when executed by the processor, determines if an entity that operates the plurality of LOBs is able to sustain the total expected loss within the second threshold time period.

15. A computer program product for rapidly assessing an impact of a plurality of emerging risks across a plurality of geographic regions, the computer program product comprising:
a non-transitory computer readable medium having computer readable program code embodied therein; and
a processor configured to execute the computer readable program code;
the computer readable program code, when executed by the processor:
identifies, within a first geographic region, a first emerging risk associated with the first geographic region;
plots a first plurality of points, each of the first plurality of points corresponding to a monetary value of a potential impact of the first emerging risk at a first time selected from among a range of times;
identifies, within a second geographic region, a second emerging risk associated with the second geographic region;
plots a second plurality of points, each of the second plurality of points corresponding to a monetary value of a potential impact of the second emerging risk at a second time selected from among the range of times; and
calculates, for a line-of-business (“LOB”) operating in the first geographic region and in the second geographic region:
whether a total threshold impact, the total comprising a sum of the first potential impact and the second potential impact, is expected to materialize within a threshold time period; and
whether the LOB is able to sustain the total threshold impact within the threshold time period.

16. The computer program product of claim 15 wherein the range of times begins at an earliest expected materialization of the first or second emerging risk and ends at a latest expected materialization of the first or second emerging risk.

17. The computer program product of claim 16 further comprising computer readable program code that when executed by the processor, at a time after the earliest expected materialization, re-plots the first plurality of points and the second plurality of points.

18. The computer program product of claim 15 further comprising computer readable program code that when executed by the processor, re-plots the first plurality of points and the second plurality of points in response to a change in an operational strategy implemented by the LOB in the first geographic region or the second geographic region.

19. The computer program product of claim 15 wherein the monetary value of the first and second potential impacts correspond to a potential loss and the total potential impact corresponds to a total expected loss.

20. The computer program product of claim 19 further comprising computer readable program code that when executed by the processor, determines if the LOB is able to sustain the total expected loss during the range of times.
